(19) United States
(12) Patent Application Publication
(10) Pub. No.: US 2017/0288911 A1
(43) Pub. Date: Oct. 5, 2017

(54) METHOD AND RECEIVER IN A WIRELESS COMMUNICATION SYSTEM

(71) Applicant: Huawei Technologies Co., Ltd., Shenzhen (CN)

(72) Inventors: Fredrik Rusek, Kista (SE); Basuki Endah Priyanto, Kista (SE)

(21) Appl. No.: 15/623,964

(22) Filed: Jun. 15, 2017

Related U.S. Application Data
(63) Continuation of application No. PCT/EP2014/077896, filed on Dec. 16, 2014.

(51) Int. Cl. H04L 25/02; H04L 27/26; H04B 7/0413; H04L 5/00

(52) U.S. Cl. CPC H04L 25/0256; H04L 25/0204; H04L 25/0228; H04L 5/0048; H04L 27/2649; H04B 7/0413

(57) ABSTRACT

Receiver and method in a receiver, for receiving a signal from a transmitter in a wireless communication system, based on OFDM. The method comprises: receiving a plurality of signals y from the transmitter; determining a group T of REs for which the CEE is assumed to be constant; extracting the determined group T of REs, from the received signals y; computing noise and CEE covariance matrix R_{ww} for the extracted T REs, initialised as: R_{ww}=(N₀+Mσ²)I; computing a MMSE filter W^{MMSE}, based on the computed noise and CEE covariance matrix R_{ww}; and obtaining an MMSE estimate \hat{x} of payload data x comprised in the received signals y, associated with the extracted T REs by applying the computed filter W^{MMSE} to the extracted T REs of the received signals: \hat{x}=W^{MMSE}y.

### CROSS-REFERENCE TO RELATED APPLICATIONS

This application is a continuation of International Application No. PCT/EP2014/077896, filed on Dec. 16, 2014, the disclosure of which is hereby incorporated by reference in its entirety.

### TECHNICAL FIELD

Implementations described herein generally pertain to a receiver and a method in a receiver, and more particularly to a mechanism for reducing impact of a channel estimation error when estimating a communication channel in a communication between transmitter and receiver in a wireless communication system.

### BACKGROUND

A necessity in almost all, wireless or wired, communication techniques is channel estimation. When an estimate of the channel is at hand, the receiver can start demodulating the payload data, received from a transmitter. However, the channel estimation stage is never perfect, meaning that the receiver's estimate of the channel is not identical to the true communication channel; the mismatch is referred to as Channel Estimation Error (CEE). Given the existence of CEE, the receiver may proceed in two ways; one is to ignore the presence of any CEE, and demodulate the payload data as if the channel estimate was perfect. A second approach is to take the presence of CEE into account and introduce suitable operations in the demodulation stage in order to minimise the influence of the CEE. This second approach generally leads to a better channel estimation.

Orthogonal Frequency Division Multiplexing (OFDM) is the dominant modulation technique in contemporary systems such as LTE and WIFI. OFDM is a method of encoding digital data on multiple carrier frequencies. OFDM is a frequency-division multiplexing scheme used as a digital multi-carrier modulation method. A large number of closely spaced orthogonal sub-carrier signals are used to carry data. The data is divided into several parallel data streams or channels, one for each sub-carrier.

In an OFDM system, the received set of signals are of the form:

y_{k,l}=H_{k,l}x_{k,l}+n_{k,l}. (1)

where y_{k,l} is the received vector at OFDM symbol k in time, and at subcarrier l in frequency, H_{k,l} is the channel matrix, x_{k,l} is the transmitted data vector, and n_{k,l} is white Gaussian noise. Each pair of time and frequency indices (k,l) will be referred to as one Resource Element (RE). During the channel estimation stage, the receiver forms an estimate Ĥ_{k,l} of each channel matrix H_{k,l}. These estimates are noisy and may be modelled as:

H_{k,l}=Ĥ_{k,l}+E_{k,l}. (2)

Inserting equation (2) into equation (1) yields:

y_{k,l}=Ĥ_{k,l}x_{k,l}+E_{k,l}x_{k,l}+n_{k,l}. (3)

Based on equation (3), it is now possible to formulate a demodulation algorithm according to the second approach mentioned above, aware of the presence of the error representing term E_{k,l} yi_{k,l}, which can achieve better performance than an algorithm that assumes that the CEE-related term is not present.

According to a first legacy method, the covariance of the total noise vector w_{k,l}=E_{k,l}x_{k,l}+n_{k,l} equals:

$${R}_{ww} = E ⌊ {w}_{k , l} {w}_{k , l}^{H} ⌋ = E ⌊ ( {E}_{k , l} {x}_{k , l} + {n}_{k , l} ) {( {E}_{k , l} {x}_{k , l} + {n}_{k , l} )}^{H} ⌋ = E ⌊ {E}_{k , l} {x}_{k , l} {x}_{k , l}^{H} {E}_{k , l}^{H} ⌋ + E ⌊ {n}_{k , l} {n}_{k , l}^{H} ⌋ = E [ {E}_{k , l} {E}_{k , l}^{H} ] + {N}_{0} I = ( {N}_{0} + M {σ}^{2} ) I ,$$

where E[ ] denotes the expectation operator, M is the number of transmit antennas, and σ/M is the standard deviation of the channel estimation error per entry of the error matrix E. In an MMSE receiver, the effect of the CEE is that the receive filter becomes

W_{k,l}^{MMSE}=H_{k,l}^{H}(H_{k,l}H_{k,l}^{H}+(N₀+Mσ²)I⁻¹.

A receiver that is unaware of σ may set σ=0.

A slightly more sophisticated second legacy method is based on the observation that the noise vector w is large in magnitude whenever the data vector x is also large in magnitude. Thus, the likelihood function of the received signal given the transmitted one becomes:

$$p ( {y}_{k , l} \vert {x}_{k , l} ) = exp ( - \frac{{‖ {y}_{k , l} - {\hat{H}}_{k , l} {x}_{k , l} ‖}^{2}}{{N}_{0} + {‖ x ‖}^{2} {σ}^{2}} ) . \qquad ( 4 )$$

A demodulator may now be implemented that operates on the basis of equation (4).

However, both legacy solutions as well as other known methods that are addressing CEE-aware MIMO demodulators are working within a single RE only, i.e., determining the CEE for each individual RE transmitted to the receiver over the channel. This however requests intensive computation and is time consuming, which is a problem in particular for a handheld radio unit such as a User Equipment (UE), for which computation power and battery capacity are limited.

### SUMMARY

It is therefore an object to obviate at least some of the above mentioned disadvantages and to improve the performance in a wireless communication system.

This and other objects are achieved by the features of the appended independent claims. Further implementation forms are apparent from the dependent claims, the description and the figures.

According to a first aspect, a method is provided in a receiver, for receiving a signal from a transmitter in a wireless communication system, based on Orthogonal Frequency Division Multiplexing (OFDM). The method comprises receiving a plurality of signals y from the transmitter. The method also comprises determining a group T of Resource Elements (REs) for which the Channel Estimation Error (CEE) is assumed to be constant. Further, the method also comprises extracting the determined group T of REs, from the received signals y. In addition, the method comprises computing noise and CEE covariance matrix R_{ww} for the extracted T REs, initialised as: R_{ww}=(N₀+Mσ²)I, where, N₀ is the noise variance, M is the number of antennas, σ² is the standard deviation of the channel estimation error and I is the identity matrix of size TM×TM. Also, the method comprises computing a Minimum Mean Square Error (MMSE) filter W^{MMSE}, based on the computed noise and CEE covariance matrix R_{ww}. Further the method comprises obtaining an MMSE estimate \hat{x} of payload data x comprised in the received signals y, associated with the extracted T REs by applying the computed filter W^{MMSE} to the extracted T REs of the received signals: \hat{x}=W^{MMSE}y.

Thanks to the disclosed method, an improved channel estimation is achieved, as groups of REs, having the same or similar CEE, are treated jointly. Thereby, the total, summarised, CEE power average out over the jointly treated REs. By an improved channel estimation, an improved performance in the wireless communication system is provided.

In a first possible implementation of the method according to the first aspect, symbol probabilities p(x) is computed, based on the obtained MMSE estimate \hat{x}, and iterating at least parts of the method according to the first aspect, wherein mean symbols associated with the extracted T REs are computed based on the computed symbol probability p(x) of the last iteration. The computed mean symbols are used for re-computing the noise and CEE covariance matrix R_{ww} in the subsequent iteration.

By iterating at least parts of the method and re-computing the noise and CEE covariance matrix R_{ww}, an improved MMSE estimation may be made.

In a second possible implementation of the method according to the first aspect, or according to the first possible implementation of the method according to the first aspect, the plurality of signals y comprises T vectors, each collected from a RE. Further, the symbol probability of the mth symbol of the kth resource element in the RE, pₖₘ(x), is computed based on an assumption of:

\hat{x}=Dx+e,

where

D=diag(W^{MMSE}H)

R=E[ee^{H}]=I−diag(Ĥ^{H}(ĤĤ^{H}+R_{ww})⁻¹Ĥ).

H is an effective channel matrix comprising T channel matrices for the T REs and “A=diag(B)” means that A is a diagonal matrix with the diagonal of B along its main diagonal, which computation comprises:

$${γ}_{km} ( x ) = {exp ( - \frac{{\vert {\hat{x}}_{km} - x \vert}^{2}}{{R}_{km , km}} )}^{\\}$$

$${p}_{km} ( x ) = \frac{{γ}_{km} ( x )}{{\sum }_{x} {γ}_{km} ( x )} .$$

Thereby, the symbol probability may be further improved.

In a third possible implementation of the method according to the first aspect, or any previous possible implementation of the method according to the first aspect, the mean symbol is computed:

$${\overline{x}}_{k , m} = {\sum }_{∀ x} {xp}_{k m} ( x ) ,$$

and mean vectors are then defined as:

x̅ₖ[x̅_{k,1}^{T}, x̅_{k,2}^{T} . . . x̅_{k,M}^{T}]^{T}, and the mean powers of the symbols is computed by:

$${\tilde{x}}_{k , m} = {\sum }_{∀ x} {\vert x \vert}^{2} {p}_{k m} ( x ) .$$

Thereby, it is further specified how computations may be performed for improving channel estimation.

In a fourth possible implementation of the method according to the first aspect, or any previous possible implementation of the method according to the first aspect, wherein the noise and CEE covariance matrix R_{ww} is computed by:

$${R}_{ww} = E [ {ww}^{H} ] = {N}_{0} I + {σ}^{2} [ \begin{matrix}{λ}_{11} & {λ}_{12} & … & {λ}_{1 T} \\ {λ}_{21} & {λ}_{22} & ⋱ & ⋮ \\ ⋮ & ⋱ & ⋱ & {λ}_{( T - 1 ) T} \\ {λ}_{T 1} & … & {λ}_{T ( T - 1 )} & {λ}_{TT}\end{matrix} ] ⊗ I ,$$

where ⊕ is Kronecker product, and:

$${λ}_{kk} = {\sum }_{m = 1}^{M} {\tilde{x}}_{k , m}$$

$${λ}_{kl} = {\overline{x}}_{l}^{H} {\overline{x}}_{k} , k \neq l .$$

Thereby, it is further specified how computations may be performed for improving channel estimation.

In a fifth possible implementation of the method according to the first aspect, or any previous possible implementation of the method according to the first aspect, the MMSE filter W^{MMSE} is computed by: W^{MMSE}=Ĥ^{H}(ĤĤ^{H}+R_{ww})⁻¹. By further specify the computations required for computing the MMSE filter, a better MMSE estimate may be achieved.

In a sixth possible implementation of the method according to the first aspect, or any previous possible implementation of the method according to the first aspect, the method is applied for a plurality of determined groups of T REs and their associated signals y, for which the CEE is assumed to be constant, until an MMSE estimate \hat{x} has been obtained for all the payload data x of signals y associated with all transmitted REs.

By grouping the REs having the same or similar CEE and treat these REs jointly during the computation and then repeat the method actions until all the transmitted REs has been grouped and an MMSE estimate \hat{x} has been obtained for all the payload data x of signals y associated with all transmitted REs, a further improved channel estimation is achieved.

In a seventh possible implementation of the method according to the first aspect, or any previous possible implementation of the method according to the first aspect, each of the received signals y over the extracted T REs is denoted as yₖ, 1≦k≦T, and each one of these signals is of the form: yₖ=Ĥₖxₖ+Exₖ+nₖ, wherein E is the channel estimation error, unknown to the UE. Thereby the disclosed method is further improved.

In an eighth possible implementation of the method according to the first aspect, or any previous possible implementation of the method according to the first aspect, the REs comprised in the group T of REs are selected based on vicinity in time or frequency of the REs. By selecting REs which are close in time or frequency of the REs, the difference in CEE is likely to be the same or similar of these REs, when grouping REs. Thereby the method is further improved.

In a ninth possible implementation of the method according to the first aspect, or any previous possible implementation of the method according to the first aspect, wherein the REs comprised in the group T of REs are selected based on Doppler effect of the channel. By selecting REs which are subjects of the same or similar Doppler effect, the difference in CEE is likely to be the same or similar of these REs, when grouping REs. Thereby the method is further improved.

In a tenth possible implementation of the method according to the first aspect, or any previous possible implementation of the method according to the first aspect, the extracted group T of REs is determined based on the current Multiple-Input Multiple-Output (MIMO) configuration and the MMSE demodulator configuration. Thereby, the method may be further improved.

In an eleventh possible implementation of the method according to the first aspect, or any previous possible implementation of the method according to the first aspect, the receiver is represented by a User Equipment (UE) and the transmitter is represented by a radio network node.

According to a second aspect, a receiver is provided, configured for receiving a signal from a transmitter in a wireless communication system, based on Orthogonal Frequency Division Multiplexing (OFDM). The receiver comprises a receiving circuit, configured to receive a plurality of signals y from the transmitter. Further, the receiver also comprises a processor, configured to determine a group T of Resource Elements (REs) for which the Channel Estimation Error (CEE) is assumed to be constant. Further, the processor also is configured to extract the determined group T of REs, from the received signals y. In addition, the processor is configured to compute noise and CEE covariance matrix R_{ww} for the extracted T REs, initialised as: R_{ww}=(N₀+Mσ²)I, where, N₀ is the noise variance, M is the number of antennas, σ² is the standard deviation of the channel estimation error and I is the identity matrix of size TM×TM. Also, the processor is further configured to compute a Minimum Mean Square Error (MMSE) filter W^{MMSE}, based on the computed noise and CEE covariance matrix R_{ww}. Further the processor is configured to obtain an MMSE estimate \hat{x} of payload data x comprised in the received signals y, associated with the extracted T REs by applying the computed filter W^{MMSE} to the extracted T REs of the received signals: \hat{x}=W^{MMSE}y.

Thanks to the disclosed receiver, an improved channel estimation is achieved, as groups of REs, having the same or similar CEE, are treated jointly. Thereby, the total, summarised, CEE power average out over the jointly treated REs. By an improved channel estimation, an improved performance in the wireless communication system is provided.

In a first possible implementation of the receiver according to the second aspect, the processor is further configured to compute symbol probabilities p(x), based on the obtained MMSE estimate \hat{x}, and iterating at least parts of the method according to the first aspect, wherein mean symbols associated with the extracted T REs are computed based on the computed symbol probability p(x) of the last iteration. The computed mean symbols are used for re-computing the noise and CEE covariance matrix R_{ww} in the subsequent iteration.

By iterating at least parts of the method and re-computing the noise and CEE covariance matrix R_{ww}, an improved MMSE estimation may be made.

In a second possible implementation of the receiver according to the second aspect, or according to the first possible implementation of the receiver according to the second aspect, the plurality of signals y comprises T vectors, each collected from an RE. Further, the processor is further configured to compute the symbol probability of the mth symbol of the kth resource element in the RE, pₖₘ(x) based on an assumption of:

\hat{x}=Dx+e

where

D=diag(W^{MMSE}H)

R=E[ee^{H}]=I−diag(Ĥ^{H}(ĤĤ^{H}+R_{ww})⁻¹Ĥ).

H is an effective channel matrix comprising T channel matrices for the T REs and “A=diag(B)” means that A is a diagonal matrix with the diagonal of B along its main diagonal, which computation comprises:

$${γ}_{k m} ( x ) = exp ( - \frac{{\vert {\hat{x}}_{k m} - x \vert}^{2}}{{R}_{k m , k m}} )$$

$${p}_{k m} ( x ) = \frac{{γ}_{k m} ( x )}{{\sum }_{x} {γ}_{k m} ( x )} .$$

Thereby, the receiver may compute symbol probability in a further improved manner.

In a third possible implementation of the receiver according to the second aspect, or any previous possible implementation of the receiver according to the second aspect, the processor is further configured to compute the mean symbol by:

$${\overline{x}}_{k , m} = {\sum }_{∀ x} {xp}_{k m} ( x ) ,$$

and define a mean vector as: x̅ₖ=[x̅_{k,1}^{T} x̅_{k,2}^{T} . . . x̅_{k,M}^{T}]^{T}, and to compute the mean powers of the symbols by:

$${\tilde{x}}_{k , m} = {\sum }_{∀ x} {\vert x \vert}^{2} {p}_{k m} ( x ) .$$

Thereby, it is further specified how computations may be performed for improving channel estimation.

In a fourth possible implementation of the receiver according to the second aspect, or any previous possible implementation of the receiver according to the second aspect, wherein the processor is further configured to compute the noise and CEE covariance matrix R_{ww} is computed by:

$${R}_{ww} = E [ {ww}^{H} ] = {N}_{0} I + {σ}^{2} [ \begin{matrix}{λ}_{11} & {λ}_{12} & … & {λ}_{1 T} \\ {λ}_{21} & {λ}_{22} & ⋱ & ⋮ \\ ⋮ & ⋱ & ⋱ & {λ}_{( T - 1 ) T} \\ {λ}_{T 1} & … & {λ}_{T ( T - 1 )} & {λ}_{TT}\end{matrix} ] ⊗ I ,$$

where ⊕ is Kronecxer product, and:

$${λ}_{kk} = {\sum }_{m = 1}^{M} {\tilde{x}}_{k , m}$$

$${λ}_{kl} = {\overline{x}}_{l}^{H} {\overline{x}}_{k} , k \neq l .$$

Thereby, it is further specified how computations may be performed for improving channel estimation.

In a fifth possible implementation of the receiver according to the second aspect, or any previous possible implementation of the receiver according to the second aspect, the processor is further configured to compute the MMSE filter W^{MMSE} by:

W^{MMSE}=Ĥ^{H}(ĤĤ^{H}+R_{ww})⁻¹.

By further specifying the computations required for computing the MMSE filter, a better MMSE estimate may be achieved.

In a sixth possible implementation of the receiver according to the second aspect, or any previous possible implementation of the receiver according to the second aspect, the processor is further configured to apply the made computations for a plurality of determined groups of T REs and their associated signals y, for which the CEE is assumed to be constant, until an MMSE estimate \hat{x} has been obtained for all the payload data x of signals y associated with all transmitted REs.

By grouping the REs having the same or similar CEE and treat these REs jointly during the computation and then repeat the method actions until all the transmitted REs has been grouped and an MMSE estimate \hat{x} has been obtained for all the payload data x of signals y associated with all transmitted REs, a further improved channel estimation is achieved.

In a seventh possible implementation of the receiver according to the second aspect, or any previous possible implementation of the receiver according to the second aspect, the receiving circuit is configured to receive each of the received signals y over the extracted T REs is denoted as yₖ, 1≦k≦T, and each one of these signals is of the form: yₖ=Ĥₖxₖ+Exₖ+nₖ, wherein E is the channel estimation error, unknown to the UE. Thereby the disclosed receiver is further improved.

In an eighth possible implementation of the receiver according to the second aspect, or any previous possible implementation of the receiver according to the second aspect, the processor is further configured to select the REs comprised in the group T of REs, based on vicinity in time or frequency of the REs.

By selecting REs which are close in time or frequency of the REs, the difference in CEE is likely to be the same or similar of these REs, when grouping REs. Thereby the receiver is further improved.

In a ninth possible implementation of the receiver according to the second aspect, or any previous possible implementation of the receiver according to the second aspect, the processor is further configured to select the REs comprised in the group T of REs, are selected based on Doppler effect of the channel. By selecting REs which are subjects of the same or similar Doppler effect, the difference in CEE is likely to be the same or similar of these REs, when grouping REs. Thereby the receiver is further improved.

In a tenth possible implementation of the receiver according to the second aspect, or any previous possible implementation of the receiver according to the second aspect, the processor is further configured to determine size of the group T of REs to extract, based on the current Multiple-Input Multiple-Output (MIMO) configuration and the MMSE demodulator configuration. Thereby, the receiver may be further improved.

In an eleventh possible implementation of the receiver according to the second aspect, or any previous possible implementation the transmitter is represented by a radio network node and the receiver is configured to receive the signal from the radio network node.

According to a third aspect, a computer program comprising program code is provided for performing a method according to the first aspect, or any previous possible implementation of the first aspect, for receiving a signal from a transmitter in a wireless communication system, based on OFDM, when the computer program is loaded into a processor (e.g. of the receiver, according to the second aspect, or any previous possible implementation of the second aspect).

Thanks to the disclosed third aspect, an improved channel estimation is achieved, as groups of REs, having the same or similar CEE, are treated jointly. Thereby, the total, summarised, CEE power average out over the jointly treated REs. By an improved channel estimation, an improved performance within a wireless communication system is provided.

Other objects, advantages and novel features of the aspects of the disclosed solutions will become apparent from the following detailed description.

According to a fourth aspect a user equipment is provided comprising a receiver according to the second aspect, or any previous possible implementation of the receiver according to the second aspect.

### BRIEF DESCRIPTION OF THE DRAWINGS

Various embodiments will be more readily understood by reference to the following description, taken with the accompanying drawings, in which:

FIG. 1A is an illustration of system architecture comprising a transmitter and a receiver, according to an embodiment;

FIG. 1B is an illustration of system architecture comprising a transmitter and a receiver, according to an embodiment;

FIG. 2 is a flow chart illustrating a method according to some embodiments;

FIG. 3 is a block diagram illustrating an embodiment;

FIG. 4 is a block diagram illustrating an embodiment;

FIG. 5 is a flow chart illustrating a method according to some embodiments; and

FIG. 6 is a block diagram illustrating a receiver according to an embodiment.

### DETAILED DESCRIPTION

Embodiments described herein are defined as a receiver and a method in a receiver, which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

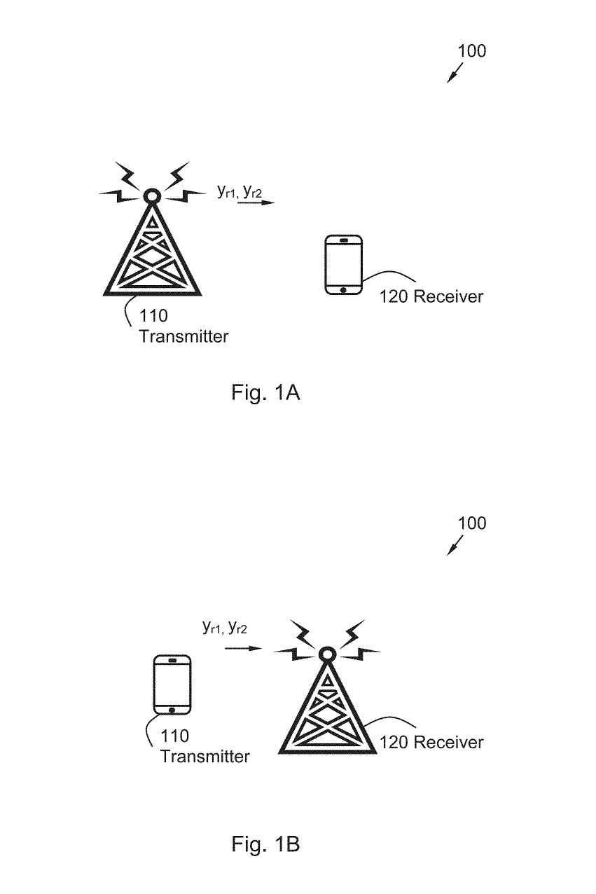

FIG. 1A is a schematic illustration over a wireless communication system 100 comprising a transmitter 110 communicating with a receiver 120. In the illustrated example, a first pilot signal yᵣ₁ and a second pilot signal yᵣ₂ are transmitted by the transmitter 110 to be received by the receiver 120. The first pilot signal yᵣ₁ may be received at the time r1 and the second pilot signal yᵣ₂ may be received at the time r2.

The wireless communication system 100 may at least partly be based on any arbitrary OFDM based access technology such as e.g. 3GPP Long Term Evolution (LTE), LTE-Advanced, LTE fourth generation mobile broadband standard, Evolved Universal Terrestrial Radio Access Network (E-UTRAN), Worldwide Interoperability for Microwave Access (WiMax), WiFi, just to mention some few options.

The wireless communication system 100 may be configured to operate according to the Time-Division Duplex (TDD), or Frequency Division Duplexing (FDD) principles for multiplexing, according to different embodiments.

In the illustrated wireless communication system 100 the transmitter 110 is comprised in a radio network node and the receiver 120 is comprised in a UE, wherein the radio network node may be serving one or more cells.

The purpose of the illustration in FIG. 1A is to provide a simplified, general overview of the methods and nodes, such as the transmitter 110 and receiver 120 herein described, and the functionalities involved. The methods, transmitter 110 and receiver 120 will subsequently, as a non-limiting example, being described in a 3GPP/LTE environment, but the embodiments of the disclosed methods, transmitter 110 and receiver 120 may operate in a wireless communication system 100 based on another access technology such as e.g., any of the above enumerated. Thus, although the embodiments of the method are described based on, and using the lingo of, 3GPP LTE systems, it is by no means limited to 3GPP LTE.

The transmitter 110 may according to some embodiments be referred to as e.g., a radio network node, a base station, a NodeB, an evolved Node Bs (eNB, or eNode B), a base transceiver station, an Access Point Base Station, a base station router, a Radio Base Stations (RBS), a macro base station, a micro base station, a pico base station, a femto base station, a Home eNodeB, a sensor, a beacon device, a relay node, a repeater or any other network node configured for communication with the receiver 120 over a wireless interface, depending e.g., of the radio access technology and terminology used.

The receiver 120 may correspondingly, in some embodiments, be represented by e.g., a UE, a wireless communication terminal, a mobile station, a mobile cellular phone, a Personal Digital Assistant (PDA), a wireless platform, a mobile station, a portable communication device, a laptop, a computer, a wireless terminal acting as a relay, a relay node, a mobile relay, a Customer Premises Equipment (CPE), a Fixed Wireless Access (FWA) nodes or any other kind of device configured to communicate wirelessly with the transmitter 110, according to different embodiments and different vocabulary used.

The UE in the present context may be, for example, portable, pocket-storable, hand-held, computer-comprised, or vehicle-mounted mobile devices, enabled to communicate voice and/or data, via the radio access network, with another entity, such as another UE or a server.

However, in other alternative embodiments, as illustrated in FIG. 1B, the situation may be reversed. Thus the receiver 120 in some embodiments may be represented by e.g. a radio network node, a base station, a NodeB, an eNB, or eNode B, a base transceiver station, an Access Point Base Station, a base station router, a RBS, a macro base station, a micro base station, a pico base station, a femto base station, a Home eNodeB, a sensor, a beacon device, a relay node, a repeater or any other network node configured for communication with the transmitter 110 over a wireless interface, depending e.g., on the radio access technology and terminology used.

Thereby, also in some such alternative embodiments the transmitter 110 may be represented by e.g., a UE, a wireless communication terminal, a mobile cellular phone, a PDA, a wireless platform, a mobile station, a portable communication device, a laptop, a computer, a wireless terminal acting as a relay, a relay node, a mobile relay, a CPE, a Fixed Wireless Access FWA nodes or any other kind of device configured to communicate wirelessly with the receiver 120, according to different embodiments and different vocabulary used.

The transmitter 110 is configured to transmit radio signals comprising information to be received by the receiver 120. Correspondingly, the receiver 120 is configured to receive radio signals comprising information transmitted by the transmitter 110.

The illustrated network setting of one receiver 120 and one transmitter 110 in FIG. 1A and FIG. 1B respectively, are to be regarded as non-limiting examples of different embodiments only. The wireless communication system 100 may comprise any other number and/or combination of transmitters 110 and/or receiver/s 120, although only one instance of a receiver 120 and a transmitter 110, respectively, are illustrated in FIG. 1A and FIG. 1B, for clarity reasons. A plurality of receivers 120 and transmitters 110 may further be involved in some embodiments.

Thus whenever “one” or “a/an” receiver 120 and/or transmitter 110 is referred to in the present context, a plurality of receivers 120 and/or transmitter 110 may be involved, according to some embodiments.

It has been observed that in practical applications, such as LTE, the channels {H_{k,l}} are highly correlated; in fact, in most cases they can be regarded as constant for large intervals of time and frequency. With nearly constant channels {H_{k,l}}, it follows that also the channel estimates {H_{k,l}} are nearly constant. It then follows that the CEEs {E_{k,l}} are also nearly constant. Thus, at each RE, there is indeed a CEE, but nearly the same CEE applies to several REs. Therefore signals may be treated jointly in order to achieve better performance.

Consider an N×M MIMO system. The total CEE power in the matrix E becomes Nσ². In conventional solutions, the demodulators are assuming that the signals y_{k,l} contain independent CEEs at all REs. However, this is not true, as the CEE is highly correlated. If it is assumed that the CEE remains constant over T REs, then the total CEE power is averaged over the T REs, rendering only a total amount Nσ²/T of power for each RE. T is the number of REs grouped together and considered to have the same or similar CEE. Hence, for large T, the effect of CEE almost vanishes, as the error of the T REs average out. The conventional methods do not take exploit this fact.

The herein presented solution is based on this observation and comprises an iterative MMSE-based demodulator that treats a group of T REs simultaneously. Further, in each group, the CEE is assumed to be identical, or the difference between CEEs in the group is at least negligible. The objective is that the total CEE power should average out over the T REs.

The herein disclosed iterative MMSE demodulator average out the CEE power over a group of T REs, by performing at least some of the subsequent actions, in some embodiments.

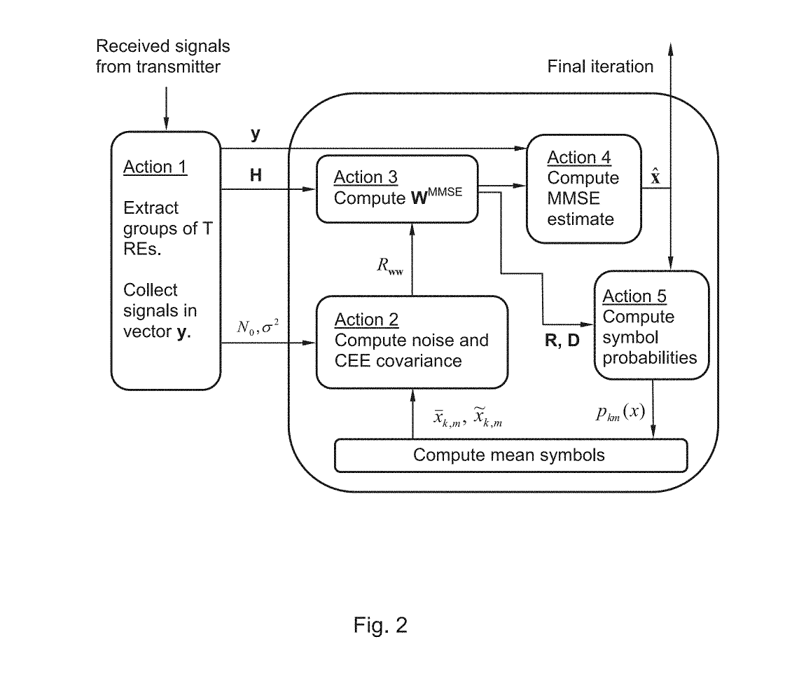

FIG. 2 illustrates an overview over some actions 1-5, according to an embodiment. At least some of the actions 1-5 may be iterated for a predetermined number of times in some embodiments. In other embodiments, a comparison may be made between the MMSE estimate \hat{x} and the previously achieved \hat{x} of the last iteration, and if the difference is smaller than a predetermined threshold value, the iteration cycle may be interrupted.

Action 1: Decide how many REs to treat jointly, and extract these REs from received signals. This number, T, of REs may comprise e.g. 2, 3, . . . , ∞ and the decided number of REs may be determined based on the Multiple Input Multiple Output (MIMO) configuration and/or the implemented MMSE demodulator. OFDM is the dominant modulation technique in contemporary systems such as LTE and WIFI. OFDM is a method of encoding digital data on multiple carrier frequencies. OFDM is a Frequency-Division Multiplexing (FDM) scheme used as a digital multi-carrier modulation method. A large number of closely spaced orthogonal sub-carrier signals are used to carry data. The data is divided into several parallel data streams or channels, one for each sub-carrier.

An OFDM based system comprises multiple REs. In this method, the REs are grouped in groups of T REs that will be jointly processed. T may be e.g., 4, in some embodiments, but the value of T is arbitrary in general. The subsequent actions may be executed for all such groups of T REs.

It may be assumed that the CEEs are identical, or at least having a negligible difference over the extracted T REs. All groups of T REs may be identically processed, and here is only described the operations of one such arbitrarily chosen group. For notational simplicity, these received signals over these T REs may be referred to as yₖ, 1≦k≦T. Each one of these signals is of the form: yₖ=Ĥₖxₖ+Exₖ+nₖ.

Note that the CEE matrices are not sub-indexed since they are assumed to be substantially identical for all k. In practice, the estimated channels are virtually also identical, but they may be sub-indexed in order to keep generality.

The herein described demodulator may be iterative, and in the described actions may be performed in one iteration. The mathematical model for the received signals becomes:

$$[ \begin{matrix}{y}_{1} \\ {y}_{2} \\ ⋮ \\ {y}_{T}\end{matrix} ] = [ \begin{matrix}{\hat{H}}_{1} & 0 & 0 & 0 \\ 0 & {\hat{H}}_{1} & 0 & 0 \\ 0 & 0 & {\hat{H}}_{1} & 0 \\ 0 & 0 & 0 & {\hat{H}}_{1}\end{matrix} ] [ \begin{matrix}{x}_{1} \\ {x}_{2} \\ ⋮ \\ {x}_{T }\end{matrix} ] + [ \begin{matrix}E & 0 & 0 & 0 \\ 0 & E & 0 & 0 \\ 0 & 0 & E & 0 \\ 0 & 0 & 0 & E\end{matrix} ] [ \begin{matrix}{x}_{1} \\ {x}_{2} \\ ⋮ \\ {x}_{T}\end{matrix} ] + [ \begin{matrix}{n}_{1} \\ {n}_{2} \\ ⋮ \\ {n}_{T}\end{matrix} ] .$$

This may be assembled into y=Ĥx+w, where w collects both the noise and the CEE related terms.

Action 2: Compute a noise and CEE covariance matrix. In the first iteration, the noise covariance is initialised differently than in later iterations, wherein the mean symbol and its variance is computed based on the output of the last iteration.

It may be assumed that there is prior information present about the data symbols in the form of a probability mass function: pₖₘ(x)=p(x_{k,m}=x), where x_{k,m} denotes the mth symbol in the vector xₖ. The mean symbol may be evaluated as:

$${\overline{x}}_{k , m} = {\sum }_{∀ x} {xp}_{k m} ( x ) ,$$

The mean vectors may then be defined as: x̅ₖ=[x̅_{k,1}^{T} x̅_{k,2}^{T} . . . x_{k,M}^{T}]^{T}. Also, the mean powers of the symbols may be computed by:

$${\tilde{x}}_{k , m} = {\sum }_{∀ x} {\vert x \vert}^{2} {p}_{k m} ( x ) .$$

However, in the first iteration, this computations of the mean symbol and its variance may be omitted.

Action 3: From the computed noise and CEE covariance matrix, compute the MMSE filter, and apply it to the received signals in order to obtain the MMSE estimate of the payload data. In this final iteration, the MMSE estimate is taken as the final output.

The covariance of the matrix w equals

$${R}_{ww} = E [ {ww}^{H} ] = {N}_{0} I + {σ}^{2} [ \begin{matrix}{λ}_{11} & {λ}_{12} & … & {λ}_{1 T} \\ {λ}_{21} & {λ}_{22} & ⋱ & ⋮ \\ ⋮ & ⋱ & ⋱ & {λ}_{( T - 1 ) T} \\ {λ}_{T 1} & … & {λ}_{T ( T - 1 )} & {λ}_{TT}\end{matrix} ] ⊗ I ,$$

where ⊕ is Kronecker product, and

$${λ}_{kk} = {\sum }_{m = 1}^{M} {\tilde{x}}_{k , m}$$

$${λ}_{kl} = {\overline{x}}_{l}^{H} {\overline{x}}_{k} , k \neq l .$$

The dimension of the matrix R_{ww} is MT×MT. In the first iteration, the covariance matrix may be initialised as: R_{ww}=(N₀+Mσ²)I.

Action 4: Construct the MMSE estimate. The noise covariance may be inserted into the MMSE filter W^{MMSE}:

W^{MMSE}=Ĥ^{H}(ĤĤ^{H}+R_{ww})⁻¹,

which yields the MMSE estimate \hat{x}:\hat{x}=W^{MMSE}y.

This MMSE filtering is performed over the T REs jointly.

Action 5: Generate symbol probabilities from the MMSE estimate \hat{x}.

A standard assumption may be to assume the following model for \hat{x}:

\hat{x}=Dx+e,

where

D=diag(W^{MMSE}H)

R=E[ee^{H}]=I−diag(Ĥ^{H}(ĤĤ^{H}+R_{ww})⁻¹Ĥ)′

and “A=diag(B)” means that A is a diagonal matrix with the diagonal of B along its main diagonal. Based on this assumption, the probability pₖₘ(x) may be computed as follows:

$${γ}_{k m} ( x ) = exp ( - \frac{{\vert {\hat{x}}_{k m} - x \vert}^{2}}{{R}_{k m , k m}} )$$

$${p}_{k m} ( x ) = \frac{{γ}_{k m} ( x )}{{\sum }_{x} {γ}_{k m} ( x )} .$$

These actions 1-5, or at least some of them, may be executed iteratively, e.g., a pre-defined number of times. Further, the described actions 1-5 may be implemented using and adapting an existing demodulator in a UE chipset.

In some embodiments, the disclosed method may be implemented in a typical UE in a receiver (e.g., a demodulator of the receiver of the UE). According to some embodiments, the utilised MMSE demodulator in the receiver 120 may be configured to treat T REs jointly. This leads to a complexity increase. A typical legacy UE may have an MMSE demodulator implemented for 4×4 and/or 8×8 MIMO. Often, the demodulator is implemented for a higher MIMO than the antenna configuration of the receiver 120.

It may then be possible to make use of the existing MMSE demodulator in the following way. In some embodiments, as an example, it may be assumed that the current MIMO configuration is 2×2. If there is a 4×4 MMSE demodulator implemented in the receiver 120, then T may be set to 2. Thereby two REs may be demodulated jointly, and consequently the effect of the CEE is reduced by a factor of 2.

Furthermore, according to some other embodiments, it may be assumed that the current MIMO configuration is 2×2. If there is an 8×8 MMSE demodulator implemented in the receiver 120, then T may be set to 4. Thereby four REs may be demodulated jointly, and consequently the effect of the CEE is reduced by a factor of 4.

In another example, it may be assumed that the current MIMO configuration of the receiver 120 may be 4×4. If there is an 8×8 MMSE demodulator implemented, then T may be set to 2. Thereby four REs may be demodulated jointly, and consequently the effect of the CEE is reduced by a factor of 2.

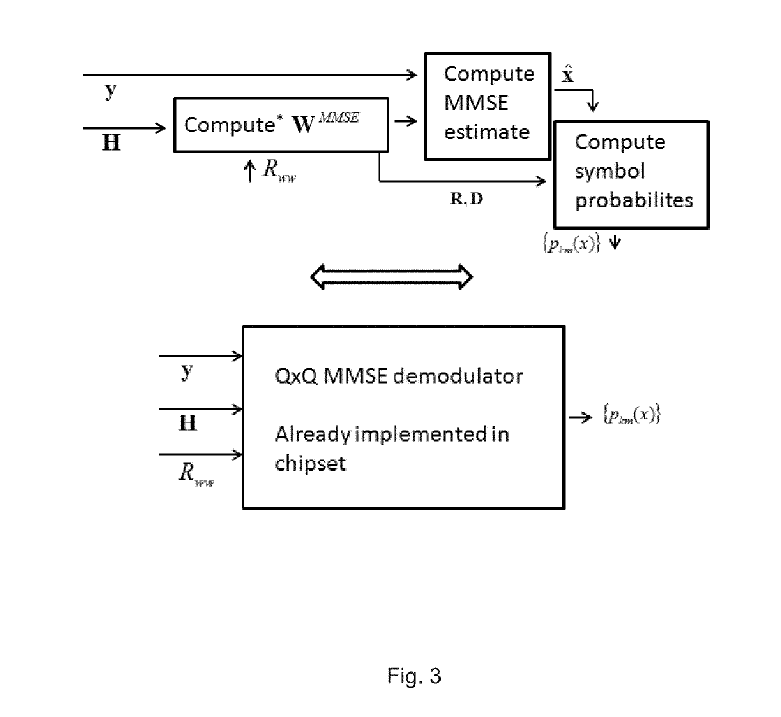

In view of FIG. 2, the parts shown in FIG. 3 constitute a MMSE demodulator. The actions computing W^{MMSE}, computing MMSE estimate and computing symbol probabilities are inserted into a single box.

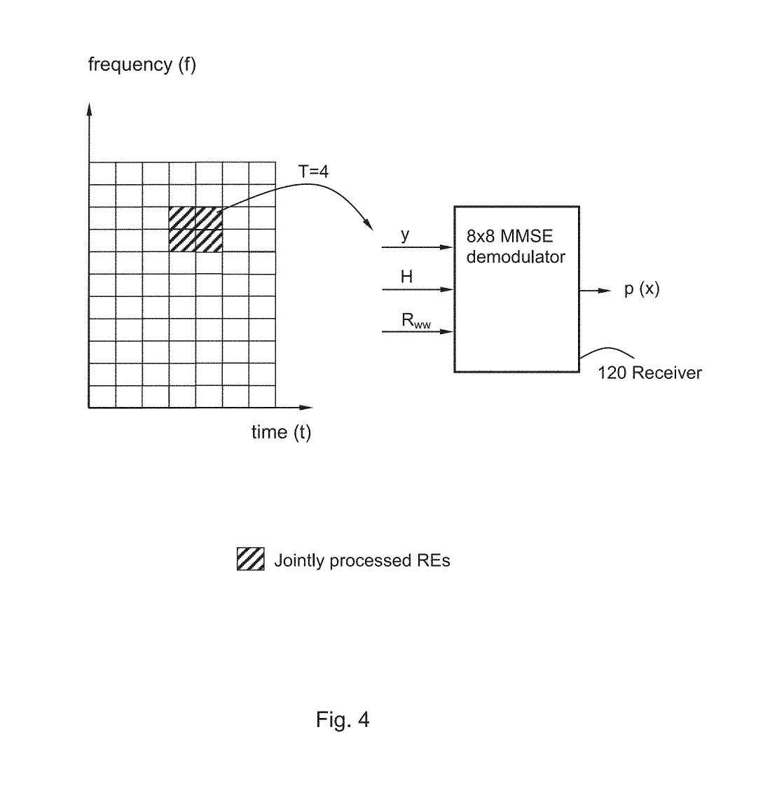

Yet an example is illustrated in FIG. 4. The illustrated example comprises a 2×2 MIMO configuration with an 8×8 MMSE demodulator implemented in the receiver 120. In this case, the group size is selected as T=4, and 4 REs are grouped together. The processing of these 4 REs may be grouped together and jointly executed by the already implemented demodulator, see FIG. 4.

Thanks to at least some of the herein described embodiments, a joint processing of T REs that exploits the fact that the channel estimation error may be assumed to be identical or neglectable over those T REs. Advantages therewith comprises firstly an easier computation, as less computations has to be made. Thereby, time, energy and computation power is saved. Another advantage by grouping REs together, is that the small possible deviations in transmission error between REs may average out, at least for big groups T. Further, by introducing an iterative computation, an improved estimation of the MMSE may be achieved. In addition, some embodiments herein may comprise exploiting a common feature in existing legacy demodulators, i.e. that the demodulator often is prepared for a higher MIMO configuration than the MIMO antenna configuration. Thereby, the disclosed method may be implemented without having to necessary significantly change demodulator in the receiver 120.

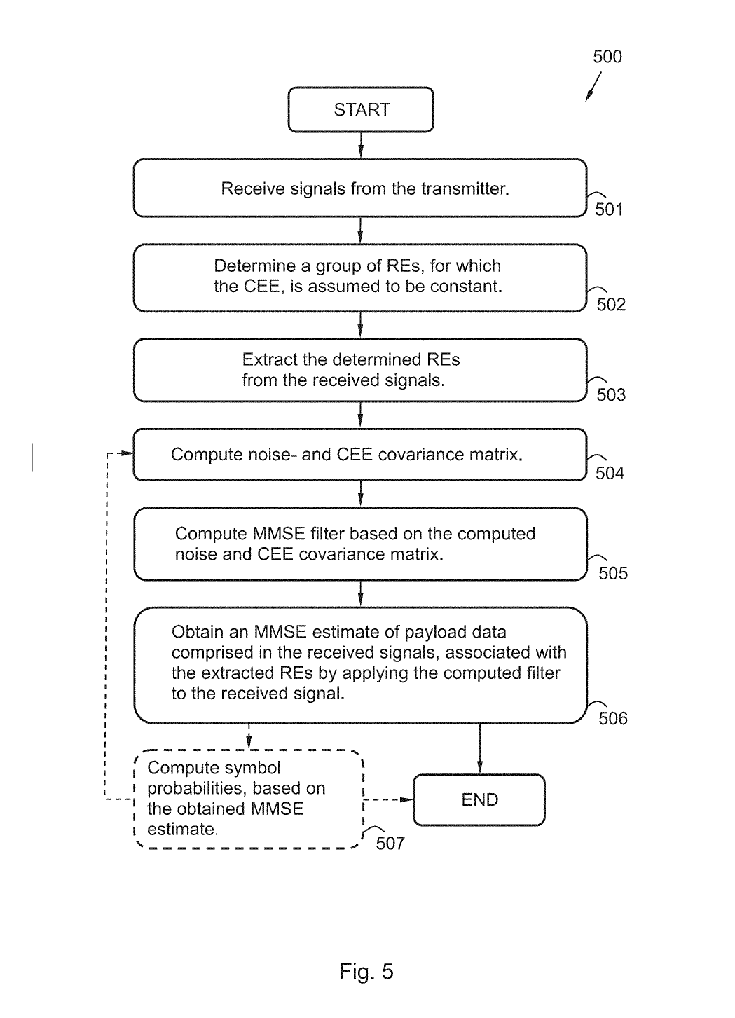

FIG. 5 illustrates an example of a method 500 in a receiver 120 according to some embodiments, for receiving a signal from a transmitter 110 in a wireless communication system 100, based on Orthogonal Frequency Division Multiplexing (OFDM). Also, the method 500 comprises estimating a Minimum Mean Square Error (MMSE) \hat{x} of payload data x, transmitted from the transmitter 110 to the receiver 120.

The receiver 120 may be represented by a User Equipment (UE) and the transmitter 110 may be represented by a radio network node or eNodeB, in some non-limiting embodiments. However, in some alternative embodiments, the receiver 120 may be represented by a radio network node and the transmitter 110 may be represented by a UE.

The wireless communication system 100 may be e.g., a 3GPP LTE system in some embodiments.

However, in some embodiments, both the transmitter 110 and the receiver 120 may be represented by radio network nodes forming a backhaul link. Thanks to embodiments herein, tuning and adjustment of the respective radio network nodes may be simplified, and the communication link may be upheld, also when e.g., transmitter warmth creates or render additional frequency offset.

Also, one or both of the transmitter 110 and/or the receiver 120 may be mobile, e.g., a mobile relay node or micro node on the roof of a bus, forming a backhaul link with a macro node. Further, both the transmitter 110 and the receiver 120 may be represented by mobile terminals in an ad-hoc network communication solution.

To appropriately receive the signal from the transmitter 110 and obtain the MMSE estimate \hat{x}, the method 500 may comprise a number of actions 501-507.

It is however to be noted that any, some or all of the described actions 501-507, may be performed in a somewhat different chronological order than the enumeration indicates, be performed simultaneously or even be performed in a completely reversed order according to different embodiments. Further, it is to be noted that some actions 501-507 may be performed in a plurality of alternative manners according to different embodiments, and that some such alternative manners may be performed only within some, but not necessarily all embodiments. In addition, some actions such as e.g., action 507 may only be performed within some alternative embodiments. Furthermore, some embodiments may comprise iterating at least some of the actions 501-507, such as e.g., 504-507. The method 500 may comprise the following actions:

Action 501 comprises receiving a plurality of signals y from the transmitter 110.

The plurality of signals y may comprise T vectors, each collected from a RE.

The received signals y over the T REs may be denoted as yₖ, 1≦k≦T, and each one of these signals may be of the form: yₖ=Ĥₖxₖ+Exₖ+nₖ, wherein E is the channel estimation error, which is unknown to the UE.

In action 502, a group T of Resource Elements (REs) is determined, for which the Channel Estimation Error (CEE) is assumed to be constant, or at least having a neglectable difference in error. The REs comprised in the group T of REs may be selected based on vicinity in time and/or frequency of the REs. Furthermore, the REs comprised in the group T of REs can be selected based on Doppler effect of the channel.

Action 503 comprises extracting the determined group T of REs, from the received signals y. Each of the received signals y over the extracted T REs may be denoted as yₖ,1≦k≦T, and each one of these signals is of the form: yₖ=Ĥₖxₖ+Exₖ+nₖ.

The REs comprised in the group T of REs may be selected and extracted based on vicinity in time or frequency of the REs.

The REs comprised in the group T of REs may be selected based on Doppler effect of the channel in some embodiments.

The extracted group T of REs may be determined 502 based on the current Multiple Input Multiple Output (MIMO) configuration and the MMSE demodulator configuration. Action 504 comprises computing a noise and CEE covariance matrix R_{ww} for the extracted T REs, initialised as: R_{ww}=(N₀+Mσ²)I, where, N₀ is the noise variance, M is the number of MIMO antennas, σ² is the standard deviation of the channel estimation error and I is the identity matrix of size TM×TM.

In some alternative embodiments, when action 504 is iterated, a mean symbol associated with the extracted T REs is computed based on the computed symbol probability pₖₘ(x) of the last iteration, which computed mean symbol is used for re-computing the noise and CEE covariance matrix R_{ww} in the subsequent iteration.

Further, the mean symbol may be computed by:

$${\overline{x}}_{k , m} = {\sum }_{∀ x} {xp}_{k m} ( x ) ,$$

and mean vectors may then be defined as: x̅ₖ=[x̅_{k,1}^{T} x̅_{k,2}^{T} . . . x̅_{k,M}^{T}]^{T}, and the mean powers of the symbols may be computed by:

$${\tilde{x}}_{k , m} = {\sum }_{∀ x} {\vert x \vert}^{2} {p}_{k m} ( x ) ,$$

in some embodiments.

Further, in some embodiments, the noise and CEE covariance matrix R_{ww} may be computed:

$${R}_{ww} = E [ {ww}^{H} ] = {N}_{0} I + {σ}^{2} [ \begin{matrix}{λ}_{11} & {λ}_{12} & … & {λ}_{1 T} \\ {λ}_{21} & {λ}_{22} & ⋱ & ⋮ \\ ⋮ & ⋱ & ⋱ & {λ}_{( T - 1 ) T} \\ {λ}_{T 1} & … & {T}_{T ( T - 1 )} & {λ}_{TT}\end{matrix} ] ⊗ I ,$$

where ⊕ is Kronecker product, and:

$${λ}_{kk} = {\sum }_{m = 1}^{M} {\tilde{x}}_{k , m}$$

$${λ}_{kl} = {\overline{x}}_{l}^{H} {\overline{x}}_{k} , k \neq l .$$

The Kronecker product, denoted by ⊕, is an operation on two matrices of arbitrary size resulting in a block matrix.

Action 505 comprises computing a Minimum Mean Square Error (MMSE) filter W^{MMSE}, based on the computed noise and CEE covariance matrix R_{ww}. In some embodiments, the MMSE filter W^{MMSE} may be computed by: W^{MMSE}=Ĥ^{H}(ĤĤ^{H}+R_{ww})⁻¹.

Action 506 comprises obtaining an MMSE estimate \hat{x} of payload data x comprised in the received signals y, associated with the extracted T REs by applying the computed filter W^{MMSE} to the extracted T REs of the received signal: \hat{x}=W^{MMSE}y.

Action 507 is an optional action, only performed within some embodiments. The action 507 comprises computing a symbol probability p(x) based on the obtained MMSE estimates and iterating actions 504-507, wherein mean symbols associated with the extracted T REs are computed based on the computed symbol probability p(x) of the last iteration, which computed mean symbols are used for re-computing 504 the noise and CEE covariance matrix R_{ww} in the subsequent iteration.

pₖₘ(x) of the mth symbol of the kth resource element in the RE. The symbol probability pₖₘ(x) may in some embodiments be computed based on an assumption of:

\hat{x}=Dx+e

where

D=diag(W^{MMSE}H)

R=E[ee^{H}]=I−diag(Ĥ^{H}(ĤĤ^{H}+R_{ww})⁻¹Ĥ)′

where H is an effective channel matrix comprising T channel matrices for the T REs and “A=diag(B)” means that A is a diagonal matrix with the diagonal of B along its main diagonal, which computation comprises:

$${γ}_{k m} ( x ) = exp ( - \frac{{\vert {\hat{x}}_{k m} - x \vert}^{2}}{{R}_{k m , k m}} )$$

$${p}_{k m} ( x ) = \frac{{γ}_{k m} ( x )}{{\sum }_{x} {γ}_{k m} ( x )} .$$

In some embodiments, the method 500 may be applied for a plurality of determined groups of T REs and their associated signals y, for which the CEE is assumed to be constant, until the payload data x for signals y associated with all transmitted REs.

The method 500 may thus be applied for a plurality of determined groups of T REs and their associated signals y, for which the CEE is assumed to be constant, until an MMSE estimate \hat{x} has been obtained for all the payload data x of signals y associated with all transmitted REs.

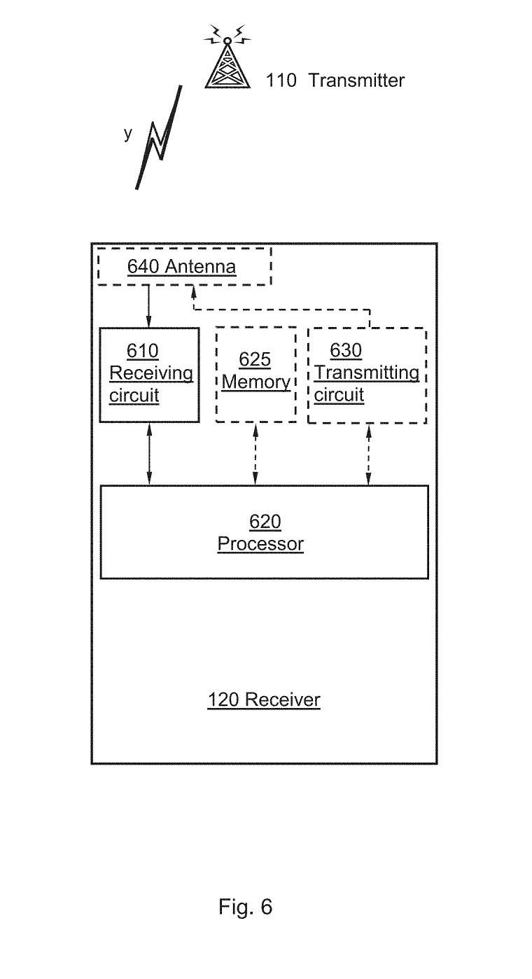

FIG. 6 illustrates an embodiment of a receiver 120 comprised in a wireless communication system 100. The receiver 120 is configured for performing at least some of the previously described method actions 501-507, for receiving a signal from a transmitter 110 in a wireless communication system 100, based on OFDM and estimating MMSE. The wireless communication network 100 may be based on 3GPP LTE.

The receiver 120 may be comprised in a User Equipment (UE) and the transmitter 110 may be comprised in a radio network node in some embodiments. In some other embodiments, the situation may be the reversed, i.e., the receiver 120 may be comprised in a radio network node and the transmitter 110 may be comprised in an UE.

Thus the receiver 120 is configured for performing the method 500 according to at least some of the previously described actions 501-507. For enhanced clarity, any internal electronics or other components of the receiver 120, not completely indispensable for understanding the herein described embodiments has been omitted from FIG. 6.

The receiver 120 comprises a receiving circuit 510, configured for receiving a plurality of signals y from the transmitter 110. The plurality of signals y may comprise T vectors, each collected from an RE.

The receiving circuit 610 may be further configured to receive each of the received signals y over the T REs, denoted as yₖ, 1≦k≦T, and each one of these signals is of the form: yₖ=Ĥₖxₖ+Exₖ+nₖ, wherein E is the channel estimation error.

Further, the receiver 120 comprises a processor 620, configured to determine a group T of Resource Elements (REs) for which the Channel Estimation Error (CEE) is assumed to be constant. The processor 620 is also configured to extract the determined group T of REs, from the received signals y. Additionally, the processor 620 is further configured to compute noise and CEE covariance matrix R_{ww} for the extracted T REs, initialised as: R_{ww}=(N₀+Mσ²)I, where: N₀ is the noise variance, M is the number of antennas, σ² is the standard deviation of the channel estimation error and I is the identity matrix of size TM×TM. Furthermore the processor 620 is configured to compute a Minimum Mean Square Error (MMSE) filter W^{MMSE}, based on the computed noise and CEE covariance matrix R_{ww}. The processor 620 is configured in addition to obtain an MMSE estimates \hat{x} of payload data x comprised in the received signals y, associated with the extracted T REs by applying the computed filter W^{MMSE} to the extracted T REs of the received signal: \hat{x}=W^{MMSE}v.

In some embodiments, the processor 620 may be further configured to compute symbol probabilities p(x) based on the obtained MMSE estimate \hat{x}, and to iterate the computations for obtaining an MMSE estimates \hat{x} of payload data x comprised in the received signals y. The mean symbols associated with the extracted T REs may be computed based on the computed symbol probability pₖₘ(x) of the last iteration. Further, the computed mean symbol may be used for re-computing noise and CEE covariance matrix R_{ww}.

The processor 620 may be further configured to compute the symbol probability of the mth symbol of the kth resource element in the RE, pₖₘ(x) based on an assumption of:

\hat{x}=Dx+e, where

D=diag(W^{MMSE}H)

R=E[ee^{H}]=I−diag(Ĥ^{H}(ĤĤ^{H}+R_{ww})⁻¹Ĥ).

and where H is an effective channel matrix comprising T channel matrices for the T REs and “A=diag(B)” means that A is a diagonal matrix with the diagonal of B along its main diagonal, which computation comprises:

$${γ}_{k m} ( x ) = exp ( - \frac{{\vert {\hat{x}}_{k m} - x \vert}^{2}}{{R}_{k m , k m}} )$$

$${p}_{k m} ( x ) = \frac{{γ}_{k m} ( x )}{{\sum }_{x} {γ}_{k m} ( x )} .$$

The processor 620 may be further configured to compute the mean symbol by:

$${\overline{x}}_{k , m} = {\sum }_{∀ x} {xp}_{k m} ( x ) ,$$

and define a mean vector as:

x̅ₖ=[x̅_{k,1}^{T} x̅_{k,2}^{T} . . . x̅_{k,M}^{T}]^{T}, and to compute the mean powers of the symbols by:

$${\tilde{x}}_{k , m} = {\sum }_{∀ x} {\vert x \vert}^{2} {p}_{k m} ( x ) .$$

The processor 620 may be further configured to compute the noise and CEE covariance matrix R_{ww} by:

$${R}_{ww} = E [ {ww}^{H} ] = {N}_{0} I + {σ}^{2} [ \begin{matrix}{λ}_{11} & {λ}_{12} & … & {λ}_{1 T} \\ {λ}_{21} & {λ}_{22} & ⋱ & ⋮ \\ ⋮ & ⋱ & ⋱ & {λ}_{( T - 1 ) T} \\ {λ}_{T 1} & … & {T}_{T ( T - 1 )} & {λ}_{TT}\end{matrix} ] ⊗ I ,$$

where ⊕ is Kronecker product, and:

$${λ}_{kk} = {\sum }_{m = 1}^{M} {\tilde{x}}_{k , m}$$

$${λ}_{kl} = {\overline{x}}_{l}^{H} {\overline{x}}_{k} , k \neq l .$$

In addition, the processor 620 may be further configured to compute the MMSE filter W by W^{MMSE}=Ĥ^{H}(ĤĤ^{H}+R_{ww})⁻¹.

The processor 620 may additionally be further configured to apply the made computations for a plurality of determined groups of T REs and their associated signals y, for which the CEE is assumed to be constant, until an MMSE estimate \hat{x} has been obtained for all the payload data x of signals y associated with all transmitted REs.

The processor 620 may also be further configured to select the REs comprised in the group T of REs, based on vicinity in time or frequency of the REs, in some embodiments.

The processor 620 may also be further configured to select the REs comprised in the group T of REs, are selected based on Doppler effect of the channel.

The processor 620 may also be further configured to determine size of the group T of REs to extract, based on the current Multiple-Input Multiple-Output (MIMO) configuration and the MMSE demodulator configuration.

Such processor 620 may comprise one or more instances of a processing circuit, i.e., a Central Processing Unit (CPU), a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

In addition according to some embodiments, the receiver 120, in some embodiments, may also comprise at least one memory 625 in the receiver 120. The optional memory 625 may comprise a physical device utilised to store data or programs, i.e., sequences of instructions, on a temporary or permanent basis in a non-transitory manner. According to some embodiments, the memory 625 may comprise integrated circuits comprising silicon-based transistors. Further, the memory 625 may be volatile or non-volatile.

In addition, the receiver 120 may comprise a transmitting circuit 630, configured for transmitting wireless signals within the wireless communication system 100.

Furthermore, the receiver 120 may also comprise an antenna 640. The antenna 640 may optionally comprise an array of antenna elements in an antenna array in some embodiments.

The actions 501-507 to be performed in the receiver 120 may be implemented through the one or more processors 620 in the receiver 120 together with computer program product for performing the functions of the actions 501-507.

Thus a non-transitory computer program comprising program code for performing the method 500 according to any of actions 501-507, for receiving a signal from a transmitter 110 in a wireless communication system 100, based on OFDM, when the computer program is loaded into a processor 620 of the receiver 120.

The non-transitory computer program product mentioned above may be provided for instance in the form of a non-transitory data carrier carrying computer program code for performing at least some of the actions 501-507 according to some embodiments when being loaded into the processor 620. The data carrier may be, e.g., a hard disk, a CD ROM disc, a memory stick, an optical storage device, a magnetic storage device or any other appropriate medium such as a disk or tape that may hold machine readable data in a non-transitory manner. The non-transitory computer program product may furthermore be provided as computer program code on a server and downloaded to the receiver 120, e.g., over an Internet or an intranet connection.

The terminology used in the description of the embodiments as illustrated in the accompanying drawings is not intended to be limiting of the described method 500 and/or receiver 120. Various changes, substitutions and/or alterations may be made, without departing from the solution embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g., a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

What is claimed is:

1. A method for use in a receiver for receiving a signal from a transmitter in a wireless communication system, based on Orthogonal Frequency Division Multiplexing (OFDM), the method comprising:
receiving a plurality of signals y from the transmitter;
determining a group T of Resource Elements (REs), for which the Channel Estimation Error (CEE) is assumed to be constant;
extracting the determined group T of REs, from the received signals y;
computing noise and CEE covariance matrix R_{ww} for the extracted T REs, initialised as: R_{ww}=(N₀+Mσ²)I,
where, N₀ is the noise variance, M is the number of antennas, σ² is the standard deviation of the channel estimation error and I is the identity matrix of size TM×TM;
computing a Minimum Mean Square Error (MMSE) filter W^{MMSE}, based on the computed noise and CEE covariance matrix R_{ww}; and
obtaining an MMSE estimates \hat{x} of payload data x comprised in the received signals y, associated with the extracted T REs by applying the computed filter W^{MMSE} to the extracted T REs of the received signals: \hat{x}=W^{MMSE}y.

2. A receiver for receiving a signal from a transmitter in a wireless communication system, based on Orthogonal Frequency Division Multiplexing (OFDM), the receiver comprising:
a receiving circuit, configured to receive a plurality of signals y from the transmitter; and
a processor, configured to:
determine a group T of Resource Elements (Res), for which the Channel Estimation Error (CEE), is assumed to be constant,
extract the determined group T of REs, from the received signals y,
compute noise and CEE covariance matrix R_{ww} for the extracted T REs, initialised as: R_{ww}=(N₀+Mσ²)I, where: N₀ is the noise variance, M is the number of antennas, σ² is the standard deviation of the channel estimation error and I is the identity matrix of size TM×TM, and
compute a Minimum Mean Square Error (MMSE) filter W^{MMSE}, based on the computed noise and CEE covariance matrix R_{ww} and obtain an MMSE estimate \hat{x} of payload data x comprised in the received signals y, associated with the extracted T REs by applying the computed filter W^{MMSE} to the extracted T REs of the received signal: \hat{x}=W^{MMSE} y.

3. The receiver according to claim 2, wherein the processor is further configured to:
compute symbol probabilities p(x) based on the obtained MMSE estimate \hat{x} and iterate the computations for obtaining an MMSE estimate \hat{x} of payload data x comprised in the received signals y, wherein mean symbols associated with the extracted T REs are computed based on the computed symbol probability pₖₘ(x) of the last iteration, which computed mean symbol is used for re-computing noise and CEE covariance matrix R_{ww}.

4. The receiver according to claim 3, wherein the plurality of signals y comprises T vectors, each collected from an RE, and wherein the processor is further configured to compute the symbol probability of the mth symbol of the kth resource element in the RE, pₖₘ(x) based on an assumption of:
\hat{x}=Dx+e
where:
D=diag(W^{MMSE}H)
R=E[ee^{H}]=I−diag(Ĥ^{H}(ĤĤ^{H}+R_{ww})⁻¹Ĥ)′
where H is an effective channel matrix comprising T channel matrices for the T REs and “A=diag(B)” means that A is a diagonal matrix with the diagonal of B along its main diagonal, which computation comprises:
$${γ}_{k m} ( x ) = exp ( - \frac{{\vert {\hat{x}}_{k m} - x \vert}^{2}}{{R}_{k m , k m}} )$$
$${p}_{k m} ( x ) = \frac{{γ}_{k m} ( x )}{{\sum }_{x} {γ}_{k m} ( x )} .$$

5. The receiver according to claim 3, wherein the processor is further configured to:
compute the mean symbol by:
$${\overline{x}}_{k , m} = {\sum }_{∀ x} {xp}_{k m} ( x ) ;$$
define a mean vector as: x̅ₖ[x̅_{k,1}^{T} x̅_{k,2}^{T} . . . x̅_{k,M}^{T}]^{T}; and
compute the mean powers of the symbols by:
$${\tilde{x}}_{k , m} = {\sum }_{∀ x} {\vert x \vert}^{2} {p}_{k m} ( x ) .$$

6. The receiver according to claim 2, wherein the processor is further configured to compute the noise and CEE covariance matrix R_{ww} by:
$${R}_{ww} = E [ {ww}^{H} ] = {N}_{0} I + {σ}^{2} [ \begin{matrix}{λ}_{11} & {λ}_{12} & … & {λ}_{1 T} \\ {λ}_{21} & {λ}_{22} & ⋱ & ⋮ \\ ⋮ & ⋱ & ⋱ & {λ}_{( T - 1 ) T} \\ {λ}_{T 1} & … & {T}_{T ( T - 1 )} & {λ}_{TT}\end{matrix} ] ⊗ I ,$$
where ⊕ is Kronecker product, and:
$${λ}_{kk} = {\sum }_{m = 1}^{M} {\tilde{x}}_{k , m}$$
$${λ}_{kl} = {\overline{x}}_{l}^{H} {\overline{x}}_{k} , k \neq l .$$

7. The receiver according to claim 2, wherein the processor is further configured to compute the MMSE filter W by: W^{MMSE}=Ĥ^{H}(ĤĤ^{H}+R_{ww})⁻¹.

8. The receiver according to claim 2, wherein the processor is further configured to apply the made computations for a plurality of determined groups of T REs and their associated signals y, for which the CEE is assumed to be constant, until an MMSE estimate \hat{x} has been obtained for all the payload data x of signals y associated with all transmitted REs.

9. The receiver according to claim 2, wherein the receiving circuit is configured to receive each of the received signals y over the T REs, denoted as tₖ, 1≦k≦T, and each one of these signals is of the form: yₖ=Ĥₖxₖ+Exₖ+nₖ, wherein E is the channel estimation error.

10. The receiver according to claim 2, wherein the processor is further configured to select the REs comprised in the group T of REs based on vicinity in time or frequency of the REs.

11. The receiver according to claim 10, wherein the processor is further configured to select the REs comprised in the group T of REs based on Doppler effect of the channel.

12. The receiver according to claim 2, wherein the processor is further configured to determine size of the group T of REs to extract based on the current Multiple-Input Multiple-Output (MIMO) configuration and the MMSE demodulator configuration.

13. The receiver according to the claim 2, wherein the transmitter is a radio network node and the receiver is configured to receive the signal from the radio network node.
